(19) United States
(12) Patent Application Publication
(10) Pub. No.: US 2020/0273031 A1
(43) Pub. Date: Aug. 27, 2020

(54) SECURE END-TO-END ONLINE TRANSACTION SYSTEMS AND METHODS

(71) Applicants: Prasanna L. Narayan, San Ramon, CA (US); Madhu Vasu, Foster City, CA (US); Amarinder Bansal, Fremont, CA (US)

(72) Inventors: Prasanna L. Narayan, San Ramon, CA (US); Madhu Vasu, Foster City, CA (US); Amarinder Bansal, Fremont, CA (US)

(21) Appl. No.: 16/801,010

(22) Filed: Feb. 25, 2020

Related U.S. Application Data
(60) Provisional application No. 62/810,294, filed on Feb. 25, 2019.

(51) Int. Cl. G06Q 20/40; G06Q 30/00; G06Q 20/38; G06Q 40/02; H04L 9/32; H04L 9/14; H04L 9/06; G06F 16/27

(52) U.S. Cl. CPC G06Q 20/401; G06Q 30/0185; G06Q 20/3829; G06Q 20/3827; G06Q 40/02; G06Q 20/4016; H04L 2209/38; H04L 9/14; H04L 9/0637; G06F 16/27; H04L 9/0643; G06Q 2220/00; H04L 9/3242

(57) ABSTRACT

Disclosed are systems and methods for providing secure end-to-end transactions between consumers, merchants, and banks. A unique identifier is generated based on information specific to the device and information specific to the user and stored in a secure area of a device. A programming module executing on the device may initiate a transaction and interact with a merchant system to complete the transaction. Information provided by the programming module may enable the merchant system to negotiate with a banking system to complete the transaction. Profile information of a user may be collected by a programming module according to user selected preferences. An interface system may provide visual content to a merchant system and a banking system to verify consumer identity.

### BACKGROUND

### Technical Field

The present disclosure relates to technologies for secure online transactions between several entities.

### Description of the Related Art

Many online retailers today are intensely focused on delivering a great digital/online shopping experience across all the user device and channels. Online and digital channel have seen a staggering growth with the advent of mobile proliferation.

While some aspects of the internet, mobile technology, and certain applications have changed the way consumers look to shop and buy online, the underlying process through which online transactions are conducted continues to be an arduous and disconnected process. Many websites, for instance, require customers to register with and establish a profile to provide personalized content and enable the site to capture information regarding customer purchases. Research shows consumers are wary of creating multiple user accounts and passwords particularly when it comes to online shopping and storing their personal information online. Providing secure information, such as account information, credit card information, and passwords, to multiple entities increases the likelihood that an unauthorized party may obtain or intercept the secure information.

### BRIEF SUMMARY

Briefly stated, embodiments of the present application are directed to methods, systems, and platforms for providing a secure interface between merchants, consumers and their banks closer to create a hassle free, personalized and secure online buying experience. According to some embodiments, the technologies disclosed herein enable smart and secure technologies powered by a network that connects a consumer's bank to one or more merchants selected by the customer. The technologies disclosed create a direct network to support today's complex e-commerce eco-system by, at least in part, partnering with organizations that power the e-commerce and payment process to drive next generation of personalization, security and convenience in digital commerce.

The systems and methods described herein facilitates identification, personalization, and secure payment between merchants, consumers, banks, and payment companies while making it seamless to consumers who want to buy and pay online. The technology disclosed herein enables a network connection between a Consumer's Bank and the merchants where they shop. The systems and platforms disclosed comprise various components, services, and functionality, including banking interfaces, merchant interfaces, and user interfaces. Banking interfaces may include components for customer enrollment and service profile and payment linking. Merchant interfaces may include service profile and payment integration, service customer recognition, and service payment verification.

For merchant users, the technology disclosed herein provides the ability to identify customers visiting their website of app without having to sign in or to establish an account, a username and a password; provides more personalized content for visiting customers based on their profile; enables merchants to obtain payment credentials directly from consumer's Bank through the system and/or platform; helps to prevent financial loss (chargeback) due to fraudulent transactions by using a specialized secure Payment Verification method within the platform. For consumer users, the technology disclosed herein provides the ability to automatically establish a profile at any participating merchant for shopping; avoid creation and maintenance of multiple user accounts and passwords for online shopping; choose which information to select and share with merchants from their own trusted banking application; provides the ability to opt out of or turn off their customer profile anytime from their banking application or through online banking; and enjoy a personalized shopping experience at participating merchants including rewards, loyalty and hassle-free checkout. For bank users, the technology disclosed herein provides a trusted and secure method and interface for consumers to shop online; enables “Top of Mind” behavior with customers when using bank provided payment methods for shopping online; drives deeper digital engagement with customers; facilitates prevention of financial loss due to fraudulent transactions by using a particular Payment Verification method disclosed herein; and enables “Access to Credit” by powering digital lending at online point of sale.

These and other benefits may be achieved according to the systems, methods, and platforms disclosed herein.

### BRIEF DESCRIPTION OF THE SEVERAL VIEWS OF THE DRAWINGS

FIG. 1 shows an environment in which a system interacts with a banking system, a merchant system 104, and a consumer device according to one or more embodiments;

FIG. 2 shows a second environment in which the system of FIG. 1 interacts with a banking system, a merchant system 104, and a consumer device according to one or more embodiments;

FIG. 3 shows a first portion of a process for enrolling a consumer with the system of FIG. 1;

FIG. 4 shows a second portion of a process for enrolling a consumer with the system of FIG. 1;

FIG. 5 shows a process involved in recognizing a consumer visiting a merchant website;

FIG. 6 shows a process involved in checking out and payment for an online transaction initiated by the consumer;

FIG. 7 shows a process for verifying a payment request;

FIG. 8 shows block structures associated with Blockchain Payment Transaction procedures implemented by the system and associated entities of FIG. 1;

FIG. 9 shows a process involved in generating and storing an encrypted unique identifier; and

FIG. 10 shows a process involved in using the encrypted unique identifier of FIG. 9.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks and the environment, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

References to the term “set” (e.g., “a set of items”), as used herein, unless otherwise noted or contradicted by context, is to be construed as a nonempty collection comprising one or more members or instances.

References to the term “subset” (e.g., “a subset of the set of items”), as used herein, unless otherwise noted or contradicted by context, is to be construed as a nonempty collection comprising one or more members or instances of a set or plurality of members or instances.

Moreover, the term “subset,” as used herein, refers to a proper subset, which is a collection of one or more members or instances that are collectively smaller in number than the set or plurality of which the subset is comprised. For instance, a subset of a set of ten items will include less than ten items and at least one item.

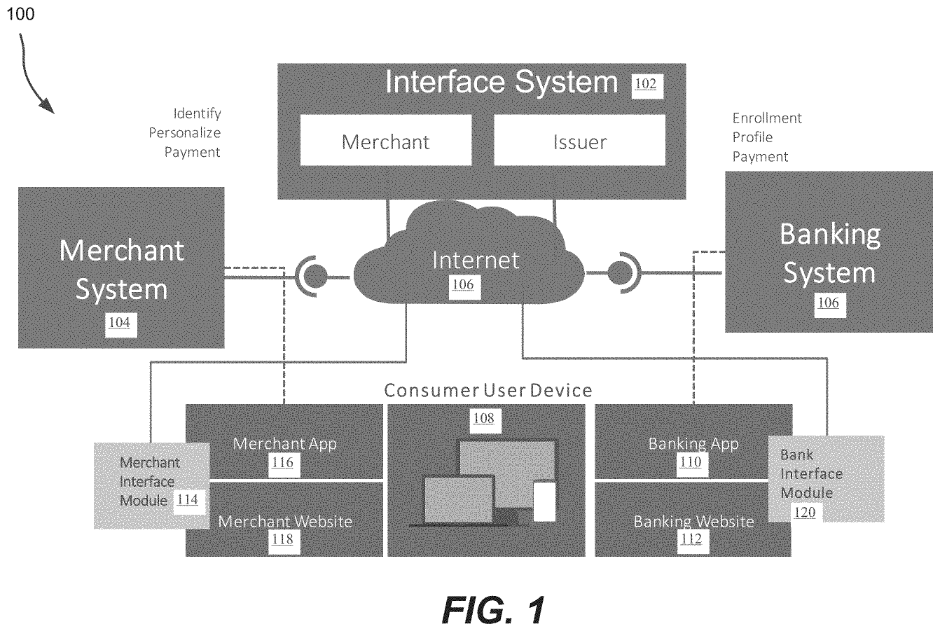

FIG. 1 shows an environment 100 in which an interface system 102 facilitates secure interaction between a merchant system 104, a bank system 106, and one or more consumer devices 108 over one or more networks 109 according to one or more embodiments.

The merchant system 104 comprises platforms and services created by an online merchant in order to present (a) a merchant website 118 within the internet browser of a user device 108 or (b) a native merchant mobile application 116 that is installed on the user device 108. The merchant system 104 may comprise one or more processors and memory coupled to the one or more processors and storing a set of instructions that, as a result of execution by the one or more processors, cause the merchant system 104 to perform the operations described herein. The merchant system 104 may further comprise one or more communication interfaces for sending and receiving communications over the network 109. The one or more communication interfaces may include one or more network adapters for communicating over a wide-area network, such as cellular communication networks, internet service provider networks, and/or satellite communication networks.

The banking system 106 comprises platforms and services created by the financial institution that offers financial services (e.g., retail bank accounts, credit cards, debit cards personal loans) to consumers in order to present (a) an online banking website 112within the internet browser of the user device 108 or (b) a native banking mobile application 110 that is installed on the consumer device 108. The banking system 106 may comprise one or more processors and memory coupled to the one or more processors and storing a set of instructions that, as a result of execution by the one or more processors, cause the banking system 106 to perform the operations described herein. The banking system 106 may further comprise one or more communication interfaces for sending and receiving communications over the network 109. The one or more communication interfaces may include one or more network adapters for communicating over a wide-area network, such as cellular communication networks, internet service provider networks, and/or satellite communication networks.

Applications for accessing the merchant system 104 and the banking system 106 via the network 109 may be installed and operated by the consumer on the user device 108 as distinct and separate activities. However, absent the interface system 102 discussed herein, the merchant system 104 and banking system 106 are separate and mutually exclusive systems that do not operate in concert to facilitate provisioning of personalized customer content, customer behavior tracking, and secure and streamlined payment processing.

The user device 108 represents any digital device such as a mobile smart phone, tablet computer, laptop, desktop computer or any device that is connected to the internet and operated by a consumer. The user device 108 may comprise one or more processors and memory coupled to the one or more processors and storing a set of instructions that, as a result of execution by the one or more processors, cause the user device 108 to perform the operations described herein. The user device 108 may further comprise one or more communication interfaces for sending and receiving communications over the network 109. The one or more communication interfaces may include one or more network adapters for communicating over a wide-area network, such as cellular communication networks, internet service provider networks, and/or satellite communication networks. The one or more communication interfaces may further comprise one or more wireless communication transceivers selected from a Wi-Fi transceiver, a Bluetooth® transceiver, a cellular communication transceiver, and a near-field communication transceiver, by way of non-limiting example.

The consumer uses the user device 108 to access the services of the merchant (e.g., via the merchant website 118 or the merchant application 116) in order to browse, shop and buy products from the merchant via the merchant system 104.

The consumer uses the network-connected user device 108 to access the services of their bank (website or application) to make financial transactions, check their balance, pay bills, view statement on line, transfer funds, etc.

The interface system 102 is a processor-based system including a platform and services that interact with the banking system 106 and merchant system 104. The interface system 102, in some embodiments, is an intermediary between the banking system 106, the merchant system 104, and user device 108s that facilitates secure and easy communication therebetween. The interface system 102 may comprise one or more processors and memory coupled to the one or more processors and storing a set of instructions that, as a result of execution by the one or more processors, cause the interface system 102 to perform the operations described herein. The interface system 102 may further comprise one or more communication interfaces for sending and receiving communications over a network. The one or more communication interfaces may include one or more network adapters for communicating over a wide-area network, such as cellular communication networks, internet service provider networks, and/or satellite communication networks.

The interface system 102 interacts with the banking system 106 to enable banking customers to create and enroll their Profile at participating merchants and select their payment methods and basic profile information that they want the merchant to use and be recognized and enhance their shopping experience.

The interface system 102 interacts with the merchant system 104 to securely provide the Profile and a unique identifier that is unique to the consumer and their device once the customer enrolls from a banking application 110 or banking website 112. The interface system 102 may generate the unique identifier, as described herein, before providing the unique identifier to the merchant system 104.

A merchant interface module 114 is provided for integrating with a merchant website 114 and/or a merchant application 116 to facilitate secure interaction between the interface system 102 and the merchant application 116 and/or the merchant website 114. The merchant interface module 114 is a program module configured to perform various operations described herein, such as identifying the consumer. The interface module 114 is installed on the user device 108 and be configured to integrate with a merchant application 116 also installed on the user device 108 to enable the merchant system 104 to “recognize” the customer visiting the merchant application 116 or merchant website 118 without the customer having to sign in with a user name and password. The term “program module,” as described herein, refers to a collection of executable instructions that is independent of another collection of executable instructions (e.g., application, program, website), but which can be integrated with and interact as an independent module with the collection of executable instructions.

The interface system 102 also interacts with a bank interface module 120 within the banking website 112 and/or the mobile banking application 110 to establish a digital fingerprint using one or more sources, such as the consumer's connected device and/or a user identifier, to generate a unique customer and device unique identifier The interface system 102 stores and securely maintains the unique identifier as long as the consumer is digitally active on that device and validates the unique identifier when the consumer accesses the banking application 110 and/or merchant application 116 in connection with the interface system 102. For example, the unique identifier may be generated as a result of the consumer enabling operation of the merchant interface module 114 or the bank interface module 120 within the m application 116, merchant website 118, the banking application 110, or the banking website 112. The merchant interface module 114 and/or the bank interface module 120, for instance, can initiate a thread independent of the associated collection of executable instructions with which it is integrated. As another example, the merchant interface module 114 and/or the bank interface module 120 may access, allocate, and/or protect areas of memory independently of the associated collection of executable instructions. An authorized user of the user device 108 may authorize and request, via the operating system of the device and/or the associated collection of executable instructions, the merchant interface module 114 and/or the bank interface module 120 to access and control aspects of the associated collection of executable instructions and/or particular hardware of the user device 108.

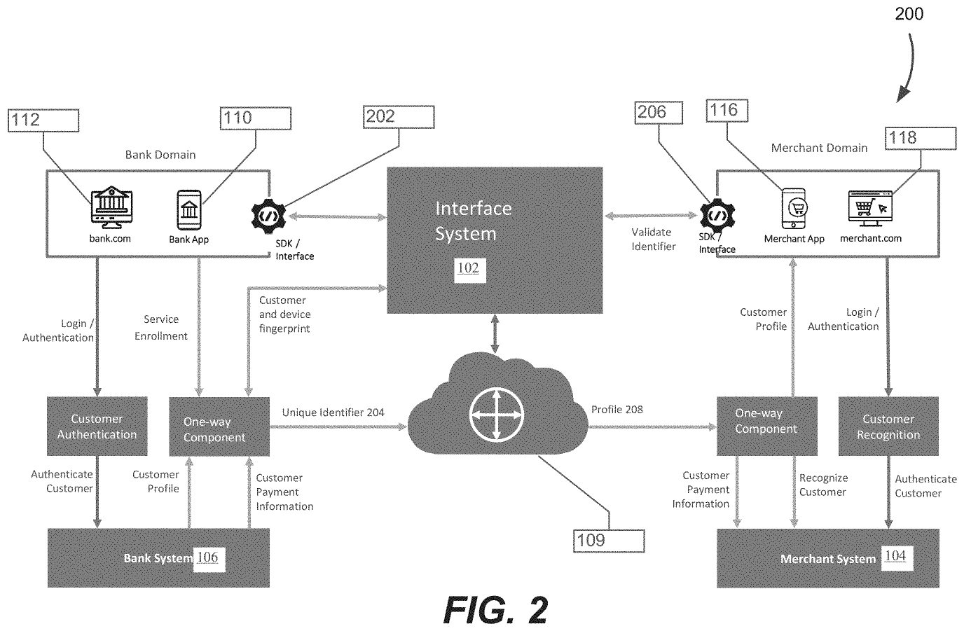

FIG. 2 shows an environment 200 in which (1) the interface system 102; (2) the banking system 106; (3) the merchant system 104s; and (4) one or more applications running on the user device 108 are integrated with each other.

Banking Integration

The interface system 102 interacts with the banking system 106 at two points:

1. Via integration of a program module 202 with the banking website 112 and/or banking application 110 of the banking system 106; and

2. Via integration with the banking system 106

Banking Website and Application Program Module

The interface system 102 provides a software program module 202 that is configured to enable the banking system 106 to incorporate the software program module 202 within the banking website 112 and mobile banking application 110. The software program module 202 is responsible for generating a unique identifier 204 that is unique to the consumer and their connected device. The unique identifier 204 may be a digital fingerprint or hash value, digest, code, etc., having a value unique to the consumer and/or the customer device. In some embodiments, the unique identifier 204 may be a value generated based at least in part on a current time, location, status, or configuration of the user device 108. The banking system 106 integrates or communicates with the interface module 120 installed on the user device 108 when the banking customer chooses to enroll and link their profile at the participating merchants and to create a Profile.

Banking System Integration

The interface system 102 integrates with the banking system 106 to provide information regarding participating merchants who are enabled on the interface system 102 for the consumer. The banking application 110 or banking website 112 may present information regarding participating merchants to the consumer in connection with the enrollment process. During the enrollment process, for example, the consumer may select participating merchants with whom the consumer consents to share information, including selecting what consumer information they wish to share (e.g., consumer shopping behavior information) and what information they wish to receive from the merchants.

Once the banking customer selects merchants with whom they wish to share information, the user authorized profile information selected for sharing and the consumer's selected payment credential information to use for completing transactions with the merchant may be collected and provided in a secure manner to the banking system 106. The programming module 202 and system that is integrated with the banking system 106 may encrypt and store the information according to one or more cryptographic protocols. The banking system 106 provides the user authorized information securely to the interface system 102 through the interfaces. In connection with a user's online shopping, purchasing or browsing associated with a selected merchant system 104, the interface system 102 may provide this information securely to the participating merchant system 104.

Interface System Integration

The interface system 102 interacts with the merchant system 104 at three points:

1. Via integration of a program module 206 with the merchant website 118 and/or the merchant application 116 of the merchant system 104;

2. Via integration with a profile 208, including a Customer Profile and Customer Payment Information; and

3. Via Payment Verification

Website and Application Program Module

The interface system 102 provides a software program module 206 that is incorporated within the merchant website 118 and/or the merchant mobile application 116 associated with the merchant system 104. The software program module 206 is responsible for detecting the unique identifier 204 that is unique to the consumer and their connected device and providing the unique identifier 204 to the merchant system 104. The merchant system 104 can then use the unique identifier 204 to recognize and identify the consumer within the merchant system 104. The profile 208 may include an option that, as a result of being enabled by the customer, allows the merchant system 104 to obtain information regarding customer behavior during the entire visit to the merchant website 118 or during a usage session with the merchant mobile application 116. The information regarding customer behavior may include details that were not possible to obtain with previously-implemented solutions. The interface system 102 may encrypt and store the profile 208 and provide the profile 208 in an encrypted form to the merchant system 104.

Customer Profile and Payment Integration

The interface system 102 integrates with the merchant system 104 to provide the profile 208, including the Customer Profile and Payment information, once the Banking customer selects the participating merchant to link their profile. The interface system 102 securely provides the customer profile information and the selected payment credential to the merchant system 104. Supporting merchant system 104 may also receive Tokenized Payment credentials supported by the Payment Networks.

Payment Verification

During a purchase process, the interface system 102 also facilitates a Payment Verification method that allows a merchant system 104 to securely verify a payment transaction of a consumer and avoid online fraud. The merchant system 104 may recognize or validate a customer using the unique identifier 204 provided by the consumer device 108 in connection with the integrated program module 206. The merchant system 104 interfaces with the interface system 102 to complete a Payment Verification. The consumer may select and authorize, via the integrated program module 206, a payment option in connection with a checkout process. The payment option is securely provided to the merchant system 104 and the banking system 106 exchanges information regarding the payment option with the merchant system 104 via one or more secure gateways provided by the interface system 102. The interface system 102 interfaces with the banking system 106 and generates a unique payment verification message, which the buying consumer has to confirm on their connected user device 108 secured and verified by the unique identifier 204. The consumer completes payment by receiving this verification message from the banking system 106 and confirming payment on the merchant website or application. The program module 206 validates the payment verification provided by Consumer on the merchant website 118 or the merchant application 116.

Enrollment Process Overview

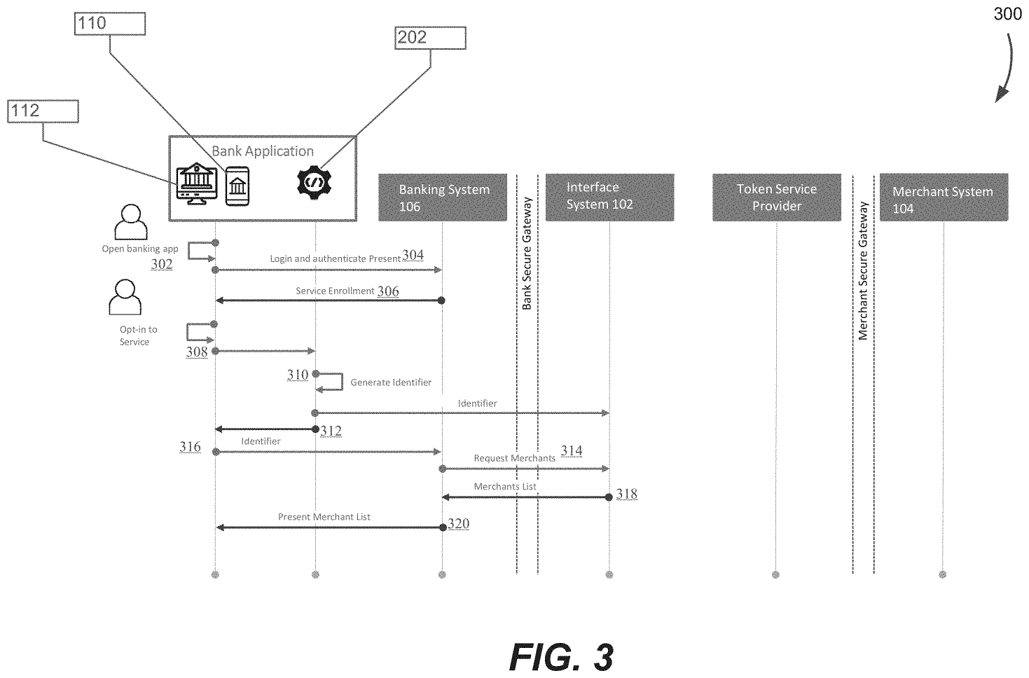

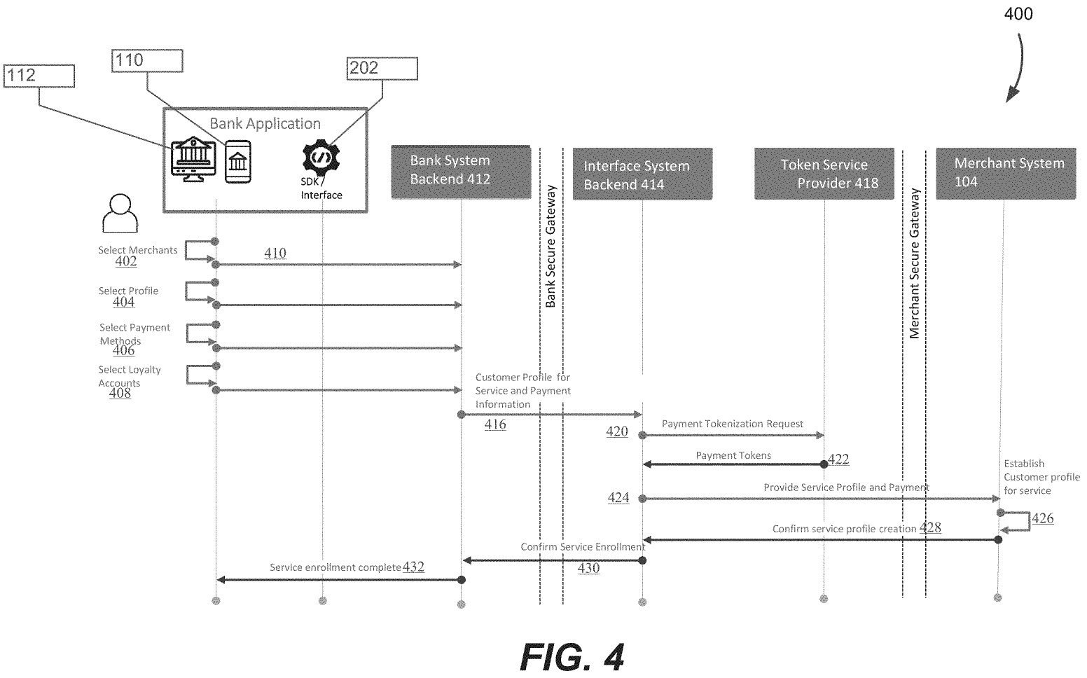

FIGS. 3 and 4 show a process for customer enrollment in the interface system 102 and customer authorization to integrate with the merchant system 104 and the banking system 106. FIG. 3 shows a first part 300 of a process of enrollment in the

Platform and FIG. 4 shows a second part 400 of a process of enrollment in the Platform according to one or more embodiments.

The process comprising the first part 300 and the second part 400 describes how a Banking customer completes the enrollment to create and link the Profile 208 and payment information of the customer with one or more participating merchants. This processes 300 and 400 may be performed as a result of the banking system 106 completing integration with the interface system 102 to provide this feature to their customers, as described herein. The processes 300 and 400 may include some or all of the following operations: Referring to the first part 300, the Banking customer accesses 302 the banking system 106 via the online banking website 112 or the banking mobile application 110. The banking system 106 authenticates the customer when they login 304 as part of a security process. The login 304 may be performed a single time such that the consumer does not need to login to any websites to achieve a customized experience, share information with merchants, or complete a simplified payment for an online transaction, as described herein.

The banking system 106 sends a communication 306 for presenting, on a user interface of the user device 108, an option for enrolling into the interface system 102. The option may be presented via the program module 202 that is integrated with an application executing on the user device 108, such as the Banking application 110, a web browser, or an independent application. If the user/consumer selects 308 the option to enroll, the consumer profile and payment information is linked with systems of the participating merchant. As a result of being linked with the merchant system 104, consumer information and behavior may be shared with the merchant, and the merchant system 104 may customize the consumer's experience on the merchant application 116 according to user preferences and behavior.

The consumer chooses to opt in 308 and enroll to create a Profile 208 for use in connection with the interface system 102. The program module 202 within the Banking Application 110 and/or the banking website 112 generates 310 the unique identifier 204 that represents the consumer and their connected user device 108.

The user device 108, via the program module 202, sends 312 the unique identifier 204 to the banking system 106 and/or the interface system 102, which may record the unique identifier 204 associated with the consumer and the connected user device 108 in data storage.

The banking system 106 requests 314 the list of participating merchants from the interface system 102. The request 314 may be as a result of an authorization transmitted 316 from the user device 108 via the program module 202. The interface system 102 provides 318 a list of participating merchants to the banking system 106.

The banking system 106 presents 320 the list of merchants to the Customer through the Banking Application 110 or online banking website 112 as part of the Enrollment Process.

Referring to the second part 400 of the enrollment process shown in FIG. 4, the consumer may select 402 one or more merchants with whom they want to share or link their profile and payment information.

The consumer selects 404 their profile information (e.g., name, email address, address) and selects 406 payment information (e.g., credit, debit accounts, bank account and or digital lending account) to link or share with the merchant. Other information, such as loyalty accounts, may be selected 408 as well. The selections in 402, 404, 406, and/or 408 are transmitted 410 to a backend 412 of the banking system 106.

The backend 412 passes 416 the profile information securely to the interface system 102 through a provided Application Program Interface (“API”) or backend 414 of the interface system 102. The API 414 may be used to establish a cryptographically secure communication channel between the bank system 106 and the interface system 102 using one or more cryptographic protocols.

The interface system 102 interfaces with the Payment Network's token service 418 to tokenize the credentials for participating merchants. The API 414 sends a request 420 for the tokenized credentials and receives 422 the tokenized payment information from the token service 418 in response.

The interface system 102 then provides 424 the Profile and Payment information to the merchant system 104. The interface system 102 may provide the Profile and Payment information of the consumer to the merchant system 104 via a second cryptographically secure communication channel established according to one or more cryptographic protocols, which may be provided by the API 414.

The merchant system 104 may establish 426 a customer profile or identify an existing customer profile associated with the consumer. The merchant system 104 may then link, add, or otherwise associate the Profile with a list of customers of the.

Once the link to the customer list is established in 426, the interface system 102 confirms 430 the enrollment completion for the selected merchants to the banking system 106.

The banking system 106 then confirms 432 completion of the enrollment to the consumer through the Banking mobile application 110 or the online Banking website 112.

Merchant Recognition

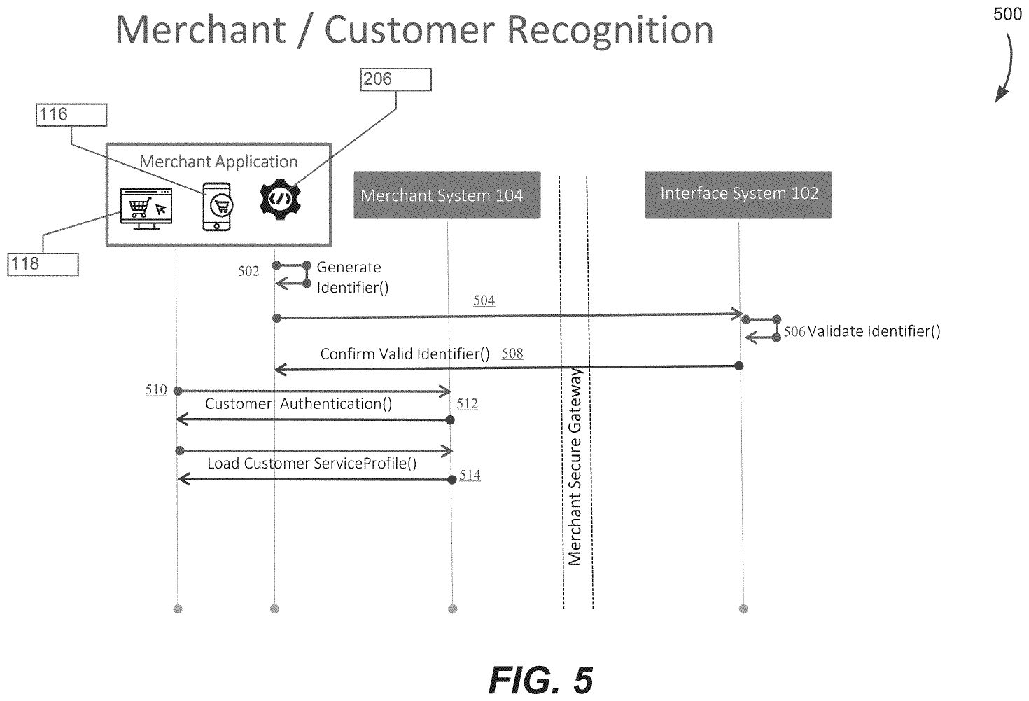

FIG. 5 shows a process 500 associated with the merchant website 118 or the merchant application 116 recognizing a visiting customer as a result of a consumer accessing the merchant website 118 or mobile application 116. The operations described with respect to FIG. 5 are performed after the consumer has enrolled in the service provided by the interface system 102, as described above with respect to FIGS. 3 and 4, and the associated description. The customer will be recognized by the process 500 and may comprise some or all of the following operations:

The consumer opens the mobile application or visits website from their connected device 108.

The program module 206 associated with the merchant website 118 or the merchant application 116 operating on the connected device 108 generates 502 a unique identifier 204 based on the consumer information and information associated with the user device 108 that is used to access the merchant application 116 or merchant website 118.

The program module 206 that is integrated with the merchant application 116 or merchant website 118 interfaces with the interface system 102 and transmits 504 the unique identifier 204 to the interface system 102 via a secure gateway established by the interface system 102. The interface system 102 assesses the unique identifier 204 and, as a result of validating 506 the unique identifier 204 as corresponding to the consumer, the interface system 102 provides a communication 508 to the program module 206 of the merchant website 118 or merchant application 116 indicating successful validation of the unique identifier 204 and its active status. Successful validation of the unique identifier 204 by the interface system 102 may be based on applying a hash function to information associated with the consumer and the user device 108 and comparing the unique identifier 204 generated with the unique identifier received in 504.

In response to receiving the indication of successful validation, the program module 206 of the merchant application 116 or merchant website 118 provides 510 the unique identifier 204 value to the merchant system 104.

The merchant system 104 uses the unique identifier 204 value to obtain 512 the Customer profile information associated with the profile 208 within the merchant system 104 and delivers 514 personalized content to the Customer via the merchant application 116 or merchant website 118 implementing the program module 206.

Merchant Checkout and Payment

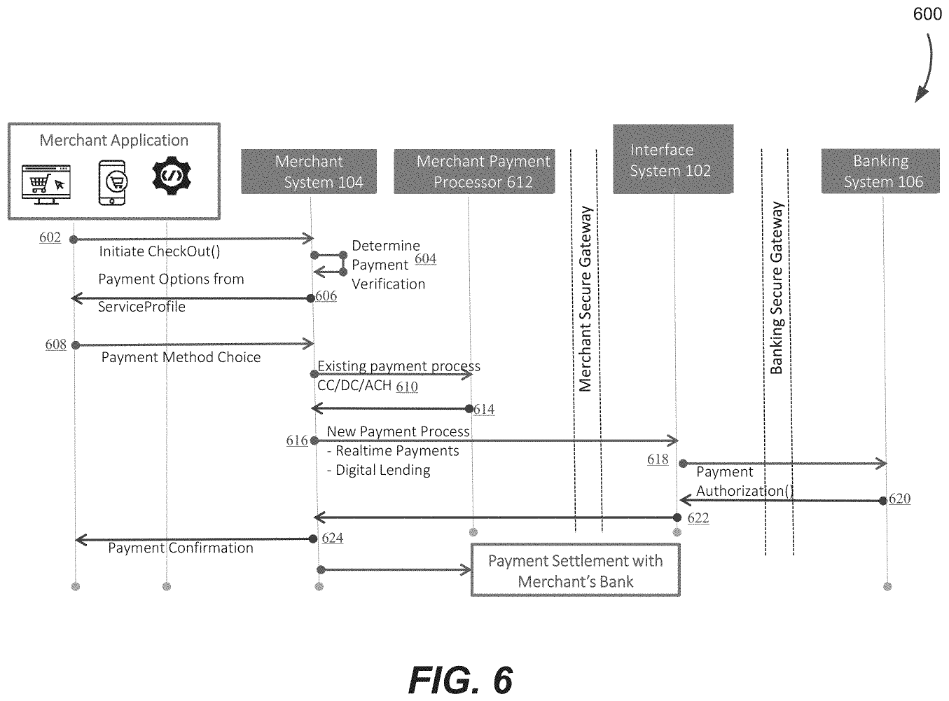

FIG. 6 shows a process 600 associated with consumer check out and payment on the website or application based on the Profile 208 and Payment information. The process 600 comprises some or all of the operations described as follows.

The consumer initiates 602 checkout of goods or services via the merchant website 118 or merchant application 116 that is implementing the program module 206.

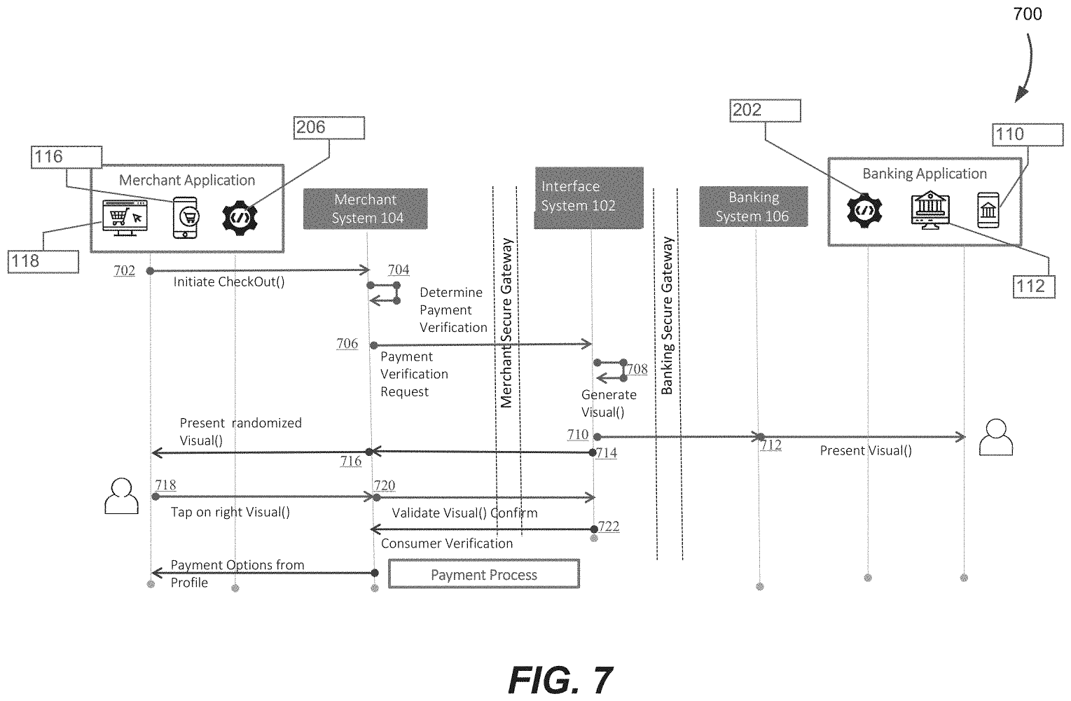

The merchant system 104 determines 604, e.g., based on the type of transactions and Purchase amount, whether to obtain additional Payment verification. Further description of Payment verification is described below with respect to the Payment Verification process overview described with respect to FIG. 7.

The merchant system 104 retrieves, from data storage, stored payment information and the consumers selected options or preferences based on the Profile 208 of the customer. The consumers selected or preferred payment options are provided 606 and presented to the consumer via the merchant application 116 or merchant website 118 as part of or in connection with the “check out” process.

In response to the options presented on the merchant application 116 or merchant website 118, the Consumer selects the preferred Payment Method for checkout, which is sent 608 to the merchant system 104 for completion of the transaction.

The merchant system 104 receives information regarding the selected Payment Options in 608. The merchant system 104 transmits 610 the Payment information to a Merchant Payment Processor 602 for certain payment methods, such as Credit Card, Debit card and Bank Account based Payments. The payment option information may be transmitted 610 in association with information identifying the consumer and an indication of consumer authentication. The merchant payment processor 612 may return 614 payment information in response to the payment processing request in 610.

For non-traditional payment methods, such as Real Time Payments and Digital Lending, which may be supported directly by the consumer's bank, the merchant system 104 may send 616 the Payment Information to the interface system 102 for payment processing.

The interface system 102 may interface with the banking system 106 and request 618 Payment Authorization for the Payment Method selected by the consumer.

The banking system 106 validates the Payment Authorization request from the interface system 102 and confirms or declines 620 the Payment Authorization sent by the interface system 102.

The interface system 102 then provides 622 a communication regarding the Payment Authorization (success or decline) to the merchant system 104. The communication 622 may include information for settlement of the payment.

As a result of the communication including an indication of successful Payment Authorization, the merchant system 104 messages 624 the confirmation to the Consumer via the merchant website 118 or Mobile Application 116.

Payment Verification Process

FIG. 7 shows a process 700 in which Payment Verification of the consumer is completed as part of Checkout and Payment for purchases via the website or application. The merchant system 104 may determine to conduct additional verification considering a variety of risk factors during an online e-commerce transaction in order to avoid a fraud loss. In response to detecting the presence of one or more indicators of risk, the merchant system 104 shall use a Payment Verification method that provides additional

Payment verification that confirms the consumer, the consumer's intent to purchase, and confirmation of the use of Payment credential by the appropriate financial institution. The risk factors may include one or more factors selected from a number of incorrect login attempts exceeding a threshold, an attempted login or transaction from a new device; changes to account information or the user device 108 configuration, status, etc.; and abnormal purchasing or browsing behavior, by way of non-limiting example. The process 700 for conducting additional verification may include some or all of the operations described as follows.

A checkout process is initiated 702 via the merchant application 116 or merchant website 118 by a user. The merchant system 104 makes a determination 704 regarding the presence of a risk indicator in connection with an online purchase and, as a result, performs additional Payment Verification as part of the online purchase.

The merchant system 104 initiates 702 and sends 706, over a network, a Payment Verification Request to the interface system 102.

The interface system 102 generates 708 a unique one-time data object corresponding to the transaction associated with the risk indicator. The data object may include a set of alphanumeric values, visual content (e.g., an image, sequence of images), or a value or set of values representative of visual content. The data object may be referred to below as the “correct data object.”

The interface system 102 sends 710 the data object to the banking system 106. The banking system 106 displays 712 visual content corresponding to the data object to the consumer through the banking mobile application 110 or banking website 112 of the banking system 106. The visual content may be presented as a notification on a display of the consumer's processor-based device 108.

In connection with sending the data object to the banking system 106, the interface system 102 sends 714 a request to verify the payment to the merchant system 104. The request may include the data object and may include a set of additional data objects corresponding to visual content. In response to the request, the merchant system 104 causes the merchant application 116 or merchant website 118 to display 716, on the consumer's processor-based device 108, a plurality of objects (e.g., visual objects, alphanumeric values) including the correct data object generated in 706. The set of objects may be randomly generated by the merchant system 104 or may be provided by the interface system 102 in association with the correct data object.

To verify the transaction, the consumer may log into or access their account in the banking application 110 or banking website 112, which will display or otherwise provide the correct data object to the consumer due to the presentation of the visual content in 712. The consumer may then access the merchant web page 118 or merchant application 116 and select 718 the visual content corresponding to the correct data object from among a plurality of visual content corresponding to the plurality of objects.

In response to selection of the visual content corresponding to the correct data object, the interface system 102 will validate 720 and confirm the correct selection by the consumer and complete 722 the Payment Verification.

The merchant system 104 will then proceed with the Payment process as explained in the previous process overview.

The interface system 102 will record the Payment Verification completed by the consumer as part of the transaction and communicate with the banking system 106 to allocate payment to the and charge an account of the consumer according to the consumer's selected payment methods.

Chain to Prevent Fraud

The interface system 102 may also implement Blockchain-based technology to prevent transaction fraud with participating players in the environments and systems described herein. In some previously-implemented solutions, merchants and banks use a costly, multi-layered approach that includes identity verification, authentication and transaction risk assessment to detect and reduce the fraud attempts. In spite of all the mitigating solutions, fraudsters are continuing to successfully circumvent the defenses of previous solutions.

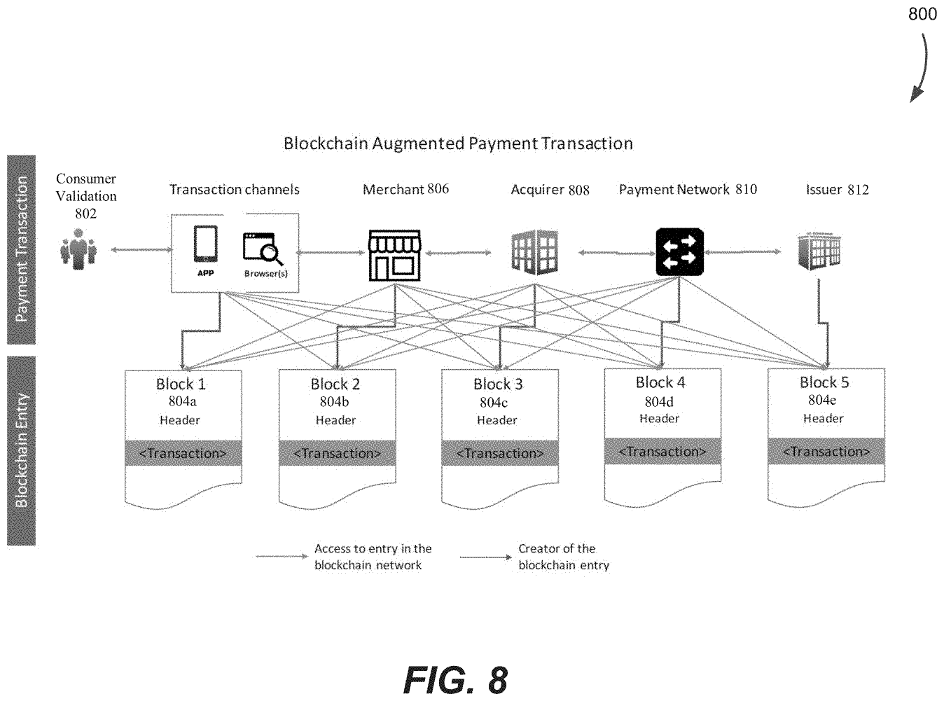

As shown in the environment 800 illustrated in FIG. 8, the interface system 102 implements a model that successfully reduces or eliminates fraud by creating an immutable record of the payment transaction. The immutable record starts with consumer validation 802 and records each transaction in a Blockchain ledger in every step, thus creating a chain-of-record that can be validated incrementally by each participant processing the payment.

A blockchain ledger entry creates a secure way for each transaction initiated by the consumer to be validated by the merchant and by all the entities within the payment process. The user device 108 initiating the transaction creates a digital signature that becomes an irrefutable record that can be verified by other parties in the payment network. The digital signature by the consumer may be a signature produced using a private key of the consumer and information specific to the transaction.

The validity of each transaction can be evidenced by demonstrating that the consumer had intent to be validated by the merchant, acquirer, payment network and the issuer during the transaction. For instance, a record of each step in the transaction may be included in a distributed blockchain ledger 804. Each record may include a hash of information associated with the particular transaction, such as information regarding time and/or date of the transaction, the consumer or merchant involved in the transaction, and the bank facilitating the transaction, by way of non-limiting example.

The foregoing Chain process 800 does not interfere with the consumer's experience or the transaction process. The application(s) used by the consumer (e.g.,

Banking application, Banking website, Merchant application, Merchant website) create a transaction block containing a digital signature of the consumer on the interface system 102′s blockchain network as a result of the program modules 202 and 206 integrated therewith. Moreover, a transaction block or ledger entry may be generated at various intermediate steps during the process, such as at the receipt or transmission of communications involving online transactions and payments. This digital signature is created with information, secured by the unique identifier technology described herein, that is known to or exchanged between the consumer and the banking system 106.

All participants, including the merchant 806, the acquirer 808 (e.g., the bank), the card issuer 812, and other entities in the payment network 810, are able to see the block chain entry in the Blockchain ledger and add their own. However, the Blockchain ledger, including each entry therein, can be verified to ensure that the ledger has not been tampered with or modified in a manner inconsistent with the intent of the entities involved in the transaction. The card issuer may validate the transactions and corresponding entries in the Blockchain ledger that were initiated by the consumer from their trusted processor-based device.

At each step of the process, the blockchain ledger 804 is updated to include transaction information and a hash value. The blockchain entry is entirely parallel process and does not require any change to the existing payment process. It also complements all existing fraud prevention solutions that are used by merchants and banks today.

Unique Identifier Generation Process

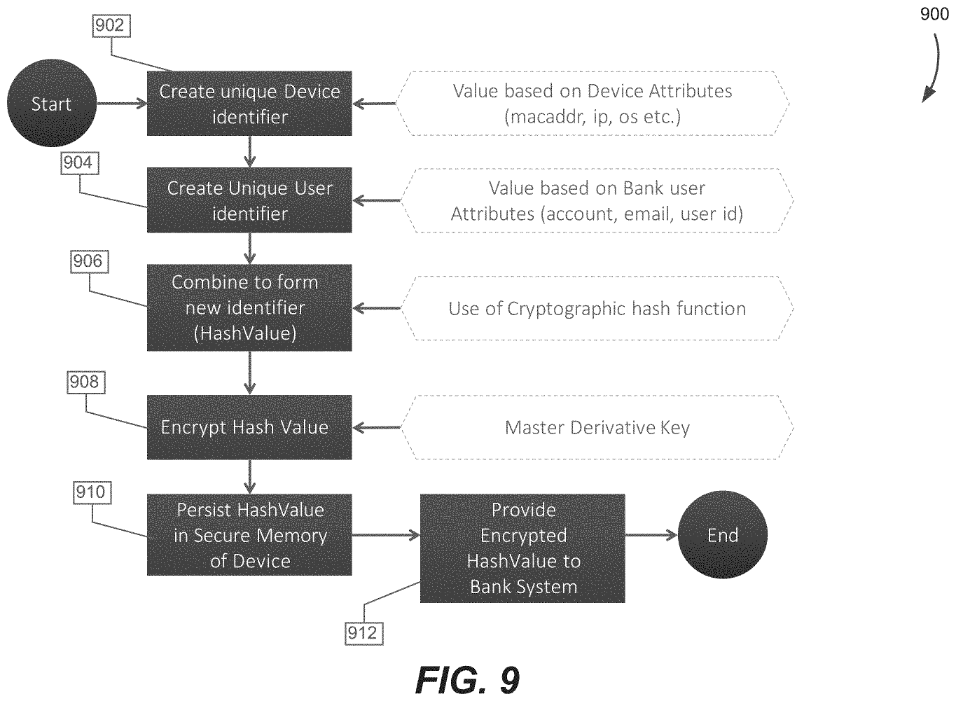

FIG. 9 shows a process 900 involved in generating a unique identifier 204, as described herein. Several conditions may exist prior to or in connection with the process 900 of generating the unique identifier. For instance, the user (i.e., consumer) may open the Banking application 110 or accesses the Banking Website 112 from their trusted device 108; the User may choose to enroll in the service provided by the interface system 102 and consents to link their credentials to a participating merchant; the banking system 106 may integrate with the interface system 102 and uses the program module 202 accessible within the banking application 110 and/or banking website 112; the banking system 106 may send a request to the program module 202 running within the Banking Application 110 or Website 112; and/or the Banking mobile application 110 and/or Banking Website 112 may complete Authentication and verification of the user.

The program module 202 uses a variety of information associated with or received from the processor-based device 108 of the user to generate 902 the unique identifier 104. Such information may include hardware, software, or operating system attributes of the device; user biometric or validation information associated with the user device 108 (e.g., facial recognition information specific to user, fingerprint, passcode, iris recognition information, subscriber identity module information); and/or network communication information associated with the device (e.g., mac address, ip address provided by carrier), by way of non-limiting example. Some or all of the foregoing information may be used to create a unique device identifier.

Next, the program module 202 uses the information provided by the banking system 106 about the user, such as username, user account identifier, user email address, to create 904 a unique user identifier. The unique user identifier may be generated according to an algorithm that is based on a hash function.

An interface program or program module associated with the interface system 102 executing on the user's trusted device then generates a unique identifier 204 using one or both of the unique device identifier and the unique user identifier generated in 902 and 904 and using an algorithm involving a Cryptographic Hash function. The Program may, for instance, concatenate or otherwise merge the unique device identifier and the unique user identifier into a single unique value, then generate the unique identifier 204 by performing a Cryptographic Hash function on the single unique value. The Program generating the unique identifier 204 may be part of an application executing on the user's trusted device. The Program, in some embodiments, is a standalone Application running on the user device that securely communicates with the interface system 102. In some embodiments, the Program may be part of the program module that is integrated with the Merchant Application 116 or the Banking Application 110, as described herein.

The interface system 102 and the banking system 106 may exchange a Master Derivative Key, which may be used to encrypt 908 the unique identifier 204 using an asymmetric key algorithm. The interface system 102 may obtain or receive the unique identifier 204from the Program or program module and encrypt the unique identifier 204 using the Master Derivative key. In some embodiments the key exchanged may be a public key of a public-private key pair in some embodiments. The private key of the public-private key pair may be securely maintained by the interface system 102. In some embodiments, the Master Derivative Key may be a key generated by the interface system 102 using a Protected Key stored in a secure storage area, such as a Hardware Security Module.

The Program stores 910 the encrypted unique identifier 204 in a secure memory location accessible to the Service Program or program module on the user's trusted processor-based device 108.

The encrypted unique identifier 204 may be securely sent 912 or otherwise provided to the banking system 106 for storage and reference within the banking system 106 domain. As a result, the banking system 106 may verify that transactions submitted by a merchant are authorized by the user using the unique identifier 204 for the user.

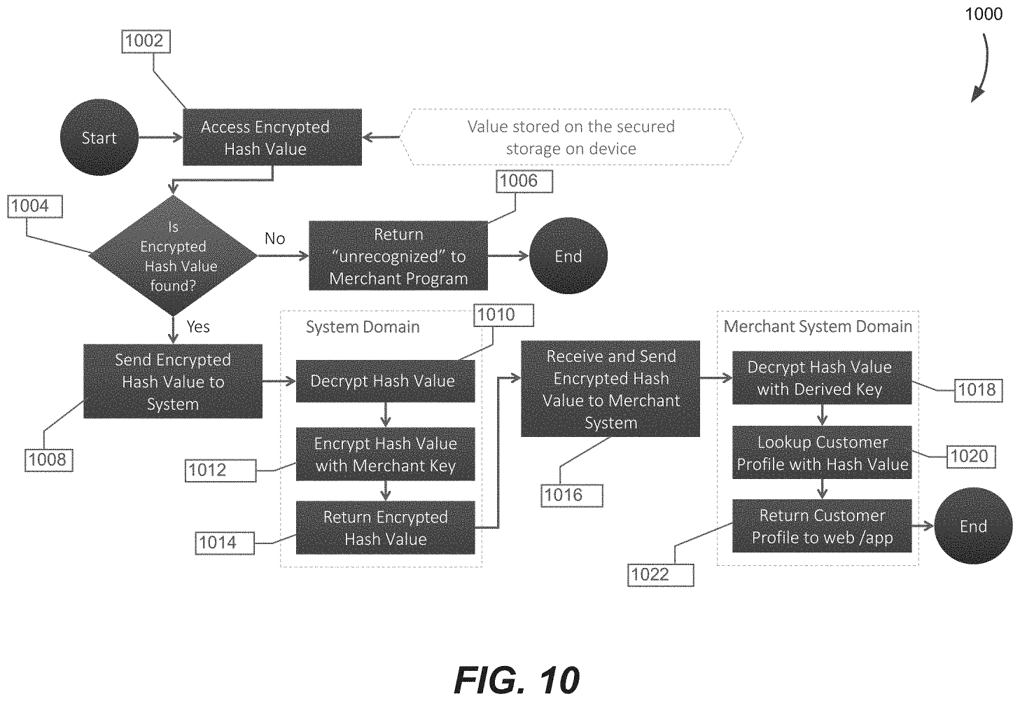

FIG. 10 shows a process 1000 in which the unique identifier is used by the merchant application or the website to authenticate or verify the visiting customer according to one or more embodiments. Several conditions may exist prior to or in connection with the process 1000. For instance, the user (i.e., consumer) may complete enrollment from the banking system 106 and links their credential to the participating merchant using the interface system 102 and operations described herein; the User may visit the merchant website 118 or the merchant mobile application 116 from the trusted user device 108; the merchant system 104 may provide a request to the program module 206 enabled within the merchant website 118 or merchant application 116 to authenticate the user device 108 using the unique identifier 204; and/or the merchant system 104 and the interface system 102 may exchange a Second Master Derivative Key that may be used to encrypt the unique identifier. In some embodiments, the key exchanged between the merchant system 104 and the interface system 102 may be a public key of a public-private key pair. The private key of the public-private key pair may be securely maintained by the interface system 102. In some embodiments, the Second Master Derivative Key may be a key generated by the interface system 102 using a Protected Key stored in a secure storage area, such as a Hardware Security Module. The process 1000 may comprise some or all of the operations described as follows.

The program module associated with the merchant website 118 or merchant application 116 accesses 1002 the secure location of the user device 108 to determine the availability of the encrypted unique identifier 204 on the device 108. The program module determines 1004 whether access to the unique identifier 204 was successful in 1002.

If the program module cannot find or unable to access the Secure location, it returns 1006 an “unrecognized” user message to the merchant system 104.

If the encrypted unique identifier value is found on the user device 108, the program module sends 1008 a request to the interface system 102 in association with a merchant identifier and the encrypted unique identifier 204.

The interface system 102 uses the Master Derivative Key to decrypt 1010 the encrypted unique identifier 204. The interface system 102 may perform additional checks to verify the validity of the unique identifier 204 based on risk indicators from the user device 108.

In response to successful decryption and validation of the encrypted unique identifier, the interface system 102 re-encrypts 1012 the unique identifier 204 to generate a Second Encrypted unique identifier using a Second Master Derivative Key specific to the merchant.

The interface system 102 then returns 1014 the Second Encrypted unique identifier 204 to the requesting program module.

The program module then provides 1016 the encrypted unique identifier 204 to the merchant system 104.

The merchant system 104 uses the Second Master Derivative Key to decrypt 1018 the Second Encrypted unique identifier 204.

The merchant system 104 uses the decrypted unique identifier 204 value to lookup 1020 or otherwise obtain the customer profile within data storage accessible by the merchant system 104.

The merchant system 104 returns the recognized Customer profile to the merchant website 118 or the merchant mobile application 116. The Customer profile can be used to customize the user's experience and track the user's behavior in the merchant application 116 or merchant website 118. The behavior is not tracked using a cookie or other similar antiquated technology—for instance, the consumer browsing behavior in is not stored to a cookie provided by a website, which then obtains and analyzes the cookie. Instead, the program module 206 installed on the user device 108 may track certain behaviors in connection with browsing, shopping, purchasing, etc., on selected websites or applications. Such information may include more information than just pages visited; the consumer behavior information obtained and stored may indicate areas of focus in particular pages (e.g., zooming in to see an image, hovering over an image), information user navigation through a particular website or application from beginning to end, information regarding time spent on a website or page, and links clicked to other pages or websites, for example. The information that the program module(s) are authorized to collect may be stored in memory or a protected area of memory of the user device 108. The consumer may adjust settings of the program module to control what information is collected, what information is shared, and what authorized recipients are permitted to do with the information shared. Therefore, the consumer/user has much greater control over the privacy and distribution of their data than was possible with previously implemented solutions.

The various embodiments described above can be combined to provide further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system for providing secure end-to-end transactions, the system comprising:
one or more processors; and
memory storing a set of instructions that, as a result of execution by the one or more processors, cause the system to:
send, over the network, profile information of a consumer to a merchant computing system identified in a list of merchants authorized for online transactions by the consumer;
receive, over the network, a request to authenticate the consumer operating a computing device, the request including a first encrypted hash value;
generate a decrypted hash value by decrypting the first encrypted hash value using a first cryptographic key of a financial institution identified in payment information associated with the consumer;
generate a second encrypted hash value by encrypting the decrypted hash value using a second cryptographic key of a merchant corresponding to the merchant computing system; and
send the second encrypted hash value to the merchant computing system.

2. The system of claim 1, wherein the set of instructions, as a result of execution by the one or more processors, further cause the system to:
receive, over the network from a banking computing system, profile information of a consumer and the list of merchants authorized for online transactions by the consumer, wherein the profile information is sent to the merchant computing system in response to receipt of the profile information.

3. The system of claim 2, wherein the profile information includes payment information indicating a set of authorized payment methods authorized by the consumer for fulfillment of online transactions.

4. The system of claim 1, wherein the request to authenticate the consumer is generated by a program module of a merchant application on the computing device.

5. The system of claim 1, wherein the set of instructions, as a result of execution by the one or more processors, further cause the system to:
receive, over the network, a first hash value from a merchant application operating on the computing device and an identifier of the consumer;
obtain a second hash value associated with the identifier of the customer;
determine a match between the first hash value and the second hash value based on a comparison between the first hash value and the second hash value; and
send, as a result of the match determined, an indication of successful validation to the merchant application.

6. The system of claim 1, wherein the set of instructions, as a result of execution by the one or more processors, further cause the system to:
receive, over the network from the merchant computing system, a request to process a payment in connection with a transaction initiated by the consumer;
send, over the network to a financial computing system of the financial institution, a request to determine whether the payment requested is authorized by the consumer;
receive, over the network from the financial computing system, information regarding consumer authorization of the payment; and
send, over the network to the merchant computing system, a communication indicating whether the payment is authorized by the consumer.

7. The system of claim 6, wherein at least one of the request to process a payment and the request to determine whether the payment requested is authorized by the consumer include an encrypted hash value.

8. The system of claim 1, wherein the set of instructions, as a result of execution by the one or more processors, further cause the system to:
generate a blockchain ledger associated with the consumer;
for each communication received in connection with the consumer, determine a validity of one or more transactions in the blockchain ledger by verifying a cryptographic entry for each of the one or more transactions; and
for each communication sent in connection with the consumer, generate a new entry in the blockchain ledger by performing a cryptographic hash function involving a cryptographic key associated with an entity interacting with the blockchain ledger.

9. At least one non-transitory computer-readable medium storing instructions that, as a result of execution by one or more processors, cause the one or more processors to:
establish a secure storage area in memory of the device that is inaccessible by an operating system of a device corresponding to the one or more processors;
obtain a first set of information specific to the device;
obtain a second set of information specific to a user of the device;
generate an encrypted hash value by causing the one or more processors to
apply a hash function to the first set of information and the second set of information to obtain a hash value, and
encrypt the hash value using a cryptographic key; and
store the encrypted hash value in the secure storage area of the device.

10. The at least one non-transitory computer-readable medium of claim 9, wherein the at least one non-transitory computer-readable medium stores further instructions that, as a result of execution by the one or more processors, cause the one or more processors to:
receive, over a network from a first entity, a request to authenticate a consumer associated with an internet transaction;
search for the encrypted hash value in the secure storage area based on information associated with the consumer; and
send, as a result of successfully locating the encrypted hash value in the secure storage area based on the search, the encrypted hash value to a second entity over the network.

11. The at least one non-transitory computer-readable medium of claim 10, wherein the at least one non-transitory computer-readable medium stores further instructions that, as a result of execution by the one or more processors, cause the one or more processors to:
send, as a result of determining that the encrypted hash value is stored in the secure storage area, customer profile information to the second entity.

12. The at least one non-transitory computer-readable medium of claim 11, wherein the first entity is a computer system of a merchant and the third entity is a computer system facilitating interaction between the merchant, the consumer, and a financial institute.

13. The at least one non-transitory computer-readable medium of claim 9, the at least one non-transitory computer-readable medium stores further instructions that, as a result of execution by the one or more processors, cause the one or more processors to:
receive, from the second entity over the network, the cryptographic key.

14. A system for providing secure end-to-end transactions, comprising:
one or more processors; and
memory storing a set of instructions that, as a result of execution by the one or more processors, cause the system to:
receive, over a network from a merchant computer system, a request to verify payment for an online transaction purportedly initiated by a consumer via a computing device;
determine a risk of fraud associated with the online transaction based on a set of factors;
generate, as a result of the risk of fraud determined, a correct data object;
send, over the network, the correct data object to a financial computing system of a financial institution associated with the consumer;
send, over the network, a request to verify an identity of the consumer that includes the correct data object to the merchant computing system;
receive, over the network, an indication of an object submitted from the computing device in connection with the request to verify the identity;
determine whether the object is a match to the correct data object;
send a communication to the merchant computing system indicating whether the identity of the consumer is verified based on a determination of whether the object is a match for the correct data object.

15. A method for providing secure end-to-end transactions involving a merchant, comprising:
receiving, over a network from a computer system, consumer profile information for a particular consumer at a first time;
storing the consumer profile information in data storage;
receiving, over a network from a consumer device, a request to obtain profile information regarding a user operating the consumer device at a second time after the first time, the request including a hash value associated with a consumer operating the consumer device;
obtaining, from data storage, the consumer profile information using the hash value; and
providing, over the network to the consumer device, the consumer profile information.

16. The method of claim 15, further comprising:
receiving, subsequent to providing the consumer profile information, information representative of consumer behavior in a virtual environment of the merchant;
evaluating the information representative of the consumer behavior;
generating customized content for presentation to the consumer on the consumer device based on a result of the evaluation; and
sending the customized content to the consumer device over the network.

17. The method of claim 15, wherein the information representative of consumer behavior in the merchant virtual environment is not a cookie.

18. The method of claim 15, further comprising:
receiving, over the network from a program module executing on the consumer device, a request to complete an online transaction in a merchant virtual environment;
obtaining, from data storage, a set of payment methods authorized by the consumer on the consumer device as a result of processing the hash value;
sending information regarding the set of payment methods to the consumer device;
receiving a communication specifying a payment method selected by a consumer; and
submitting a request to fulfill payment for the online transaction to a financial computing system of a financial institution.

19. The method of claim 18, wherein the request to fulfill payment includes a second hash value associated with the consumer.

20. The method of claim 15, wherein the hash value is an encrypted hash value, the method further comprising:
applying a hash function to the consumer profile information received at the first time to generate a second hash value, wherein the consumer profile information is stored in the data storage in a location corresponding to the second hash value;
applying a cryptographic key to the encrypted hash value to obtain a decrypted hash value; and
obtaining the consumer profile information from the location in the data storage based on the decrypted hash value.

21. A method for providing secure end-to-end transactions involving a financial institution, comprising:
receiving, over a network, an encrypted hash value generated via a program module executing on a consumer device;
providing, over the network, a list of merchants to the consumer device;
receiving, over the network from the consumer device, a selection of one or more merchants authorized to receive information regarding a consumer associated with the encrypted hash value, profile information of the consumer, and payment information for the consumer;
verifying the payment information; and
sending the payment information and profile information to a computer system via an application programming interface.

22. The method of claim 21, further comprising:
decrypting the encrypted hash value using a cryptographic key to generate a hash value; and
storing the profile information and payment information in a location in data storage based on the hash value.

23. The method of claim 21, further comprising:
receiving, over the network from the computer system, a request to remit payment to a merchant on behalf of the consumer, the request including a second encrypted hash value; and
fulfilling the request to remit payment as a result of verifying that the second encrypted hash value corresponds to the profile information of the consumer.

24. A method for providing secure end-to-end transactions, comprising:
receiving, over a network from a program module executing on a consumer device, a first encrypted hash value, consumer profile information, and a list of consumer selected merchants;
applying a first cryptographic key to the first encrypted hash value to produce a first hash value;
storing the consumer profile information in a location in data storage according to the first hash value; and
sending, over the network to a merchant computer system of a merchant specified in the list of consumer selected merchants, the consumer profile information over an application programming interface.
